(19) United States
(12) Patent Application Publication
(10) Pub. No.: US 2022/0188766 A1
(43) Pub. Date: Jun. 16, 2022

(54) SERVER, SYSTEM, CONTROL METHOD FOR SERVER, PROGRAM, AND ELECTRONIC DEVICE

(71) Applicant: KYOCERA Corporation, Kyoto (JP)

(72) Inventors: Takaomi ARAKI, Yokohama-shi (JP); Toshikazu KAWAUCHI, Yokohama-shi (JP); Gen MATSUI, Tokyo (JP)

(73) Assignee: KYOCERA Corporation, Kyoto (JP)

(21) Appl. No.: 17/653,536

(22) Filed: Mar. 4, 2022

Related U.S. Application Data
(63) Continuation of application No. PCT/JP2020/021419, filed on May 29, 2020.

(30) Foreign Application Priority Data
Sep. 13, 2019 (JP) 2019-167633

(51) Int. Cl. G06Q 10/08; G07C 9/00

(52) U.S. Cl. CPC G06Q 10/0836; G07C 9/00896; G07C 9/00571

(57) ABSTRACT

A server capable of connecting in a wired or wireless manner to a storage apparatus that stores a package delivered to a recipient, and an other electronic device, includes a communication unit, a storage unit, and a controller. The communication unit communicates with the storage apparatus and the other electronic device. The storage unit stores first information indicating a home probability of the recipient of the package. The controller controls the communication unit such that the first information stored in the storage unit and second information that is acquired from the storage apparatus and that indicates an availability of the storage apparatus are sent to the other electronic device in response to a request from the other electronic device, received by the communication unit.

### CROSS-REFERENCE TO RELATED APPLICATIONS

This application claims the benefit of Japanese Patent Application No. 2019-167633 filed Sep. 13, 2019, which is hereby incorporated by reference herein in its entirety.

### TECHNICAL FIELD

The present disclosure relates to a server, a system, control method for a server, a program, and an electronic device.

### BACKGROUND ART

In recent years, with the growth of an e-commerce market, the number of courier services handled at the time when commercial products and the like bought or sold by, for example, mail order or the like are delivered is rapidly increasing. The number of nuclear-family households and the number of single-person households are increasing, particularly, mainly in urban areas in Japan. For this reason, there can be cases where recipients are often absent at the time when couriers deliver packages, and the couriers can be forced to deliver the packages again.

In order to handle such a situation, for example, a package delivery box may be installed at the entrance or the like of a collective housing, such as an apartment house and a condominium. A package delivery box is capable of storing a delivery package addressed to a recipient even when the delivery package is delivered while the recipient is absent. There has been suggested an attempt to efficiently use such a package delivery box.

There also has been suggested an attempt to improve efficiency at the time when delivery companies, such as couriers, deliver packages to customers. For example, PTL 1 suggests promoting the efficiency of delivery work in consideration of the home probability of a customer and a delivery time by using a computer system that manages a delivery schedule.

### CITATION LIST

### Patent Literature

PTL 1: Japanese Unexamined Patent Application Publication No. 2013-167972

### SUMMARY OF INVENTION

According to one embodiment, a server s capable of connecting in a wired or wireless manner to a storage apparatus that stores a package delivered to a recipient, and an other electronic device. The server includes a communication unit that communicates with the storage apparatus and the other electronic device, a storage unit that stores first information indicating a home probability of the recipient of the package, and a controller that controls the communication unit such that the first information stored in the storage unit and second information that s acquired from the storage apparatus and that indicates an availability of the storage apparatus are sent to the other electronic device in response to a request from the other electronic device, received by the communication unit.

A system according to one embodiment includes a storage apparatus that stores a package delivered to a recipient, an other electronic device, and a server that communicates with the storage apparatus and the other electronic device. The server includes a communication unit that communicates with the storage apparatus and the other electronic device, a storage unit that stores first information indicating a home probability of the recipient of the package, and a controller that controls the communication unit such that the first information stored in the storage unit and second information that is acquired from the storage apparatus and that indicates an availability of the storage apparatus are sent to the other electronic device in response to a request from the other electronic device, received by the communication unit.

A control method for a server according to one embodiment is a control method for a server capable of connecting in a wired or wireless manner to a storage apparatus that stores a package delivered to a recipient, and an other electronic device. The control method includes a step of communicating, by a communication unit, with the storage apparatus and the other electronic device, a step of storing, by a storage unit, first information indicating a home probability of the recipient of the package, and a step of controlling, by a controller, the communication unit such that the first information stored in the storage unit and second information that is acquired from the storage apparatus and that indicates an availability of the storage apparatus are sent to the other electronic device in response to a request from the other electronic device, received by the communication unit.

A program according to one embodiment causing a computer, capable of connecting in a wired or wireless manner to a storage apparatus that stores a package delivered to a recipient, and an other electronic device, to execute a step of communicating, by a communication unit, with the storage apparatus and the other electronic device, a step of storing, by a storage unit, first information indicating a home probability of the recipient of the package, and a step of controlling, by a controller, the communication unit such that the first information stored in the storage unit and second information that is acquired from the storage apparatus and that indicates an availability of the storage apparatus are sent to the other electronic device in response to a request from the other electronic device, received by the communication unit.

An electronic device according to one embodiment includes a communication unit that directly or indirectly communicates with a storage apparatus that stores a package, a display unit that displays first information indicating a home probability of a recipient of the package and second information indicating an availability of the storage apparatus, and a controller that displays on the display unit at least one of the first information and the second Information, changed in accordance with a fact that the package stored in the storage apparatus is taken out.

### BRIEF DESCRIPTION OF DRAWINGS

FIG. 1 is a configuration diagram of a delivery system according to one embodiment.

FIG. 2 is a functional block diagram schematically showing the configuration of a management server according to one embodiment.

FIG. 3 is a functional block diagram schematically showing the configuration of a delivery box according to one embodiment.

FIG. 4 is a functional block diagram schematically showing the configuration of a company server according to one embodiment.

FIG. 5 is a functional block diagram schematically showing the configuration of a company terminal according to one embodiment.

FIG. 6 is a view illustrating the operation of the system according to one embodiment.

FIG. 7 is a table showing an example of information to be recorded by the management server according to one embodiment.

FIG. 8 is a view illustrating the operation of the system according to one embodiment.

FIG. 9 is a view illustrating the operation of the system according to one embodiment.

FIG. 10 is a view illustrating the operation of the system according to one embodiment.

FIG. 11 is a configuration diagram of a delivery system according to one embodiment.

FIG. 12 is a functional block diagram schematically showing the configuration of a recipient terminal according to one embodiment.

FIG. 13 is a view illustrating the operation of the system according to one embodiment.

### DESCRIPTION OF EMBODIMENTS

If the efficiency of delivery of a package is promoted in a service to deliver a package to a recipient, it can be useful for both a delivery company and a recipient of a package. It is an object of the present disclosure to provide a server, a system, a control method for a server, a program, and an electronic device, which can promote the efficiency of delivery of a package in a service to deliver a package to a recipient. According to one embodiment, it is possible to provide a server, a system, a control method for a server, a program, and an electronic device, which can promote the efficiency of delivery of a package in a service to deliver a package to a recipient.

In the present disclosure, the “storage apparatus” may be an apparatus that stores a package, such as a commercial product, to be delivered by, for example, a courier service or the like. For example, the “storage apparatus” may be a package delivery box as described above. Specifically, the “storage apparatus” may be, for example, a delivery box or a delivery locker. In the present disclosure, the “storage apparatus” may be a device or apparatus that is driven by electric power. Here, “storing” may be storing an article, such as a delivered commercial product, in a certain place. In the present disclosure, the “user” of a storage apparatus may be a person who uses the storage apparatus according to one embodiment. The “user” of a storage apparatus may be not only, for example, a person concerned with a recipient of a package delivered by a courier service, such as the recipient and a family of the recipient, but also, for example, a staff member of a delivery company or the like that delivers a package by means of courier service.

In the present disclosure, the “courier service” may be typically a service to deliver a lightweight small package to an ordinary household or the like. However, the “courier service” in the present disclosure is not limited to a service for an ordinary household or the like. A package to be delivered by the “courier service” in the present disclosure does not need to be lightweight or is not limited to a small package. In the present disclosure, the “package” may be, for example, an article to be carried or transported, such as a commercial product to be delivered by a delivery company of a courier service or the like.

Hereinafter, a system including a management server according to one embodiment will be described with reference to the drawings.

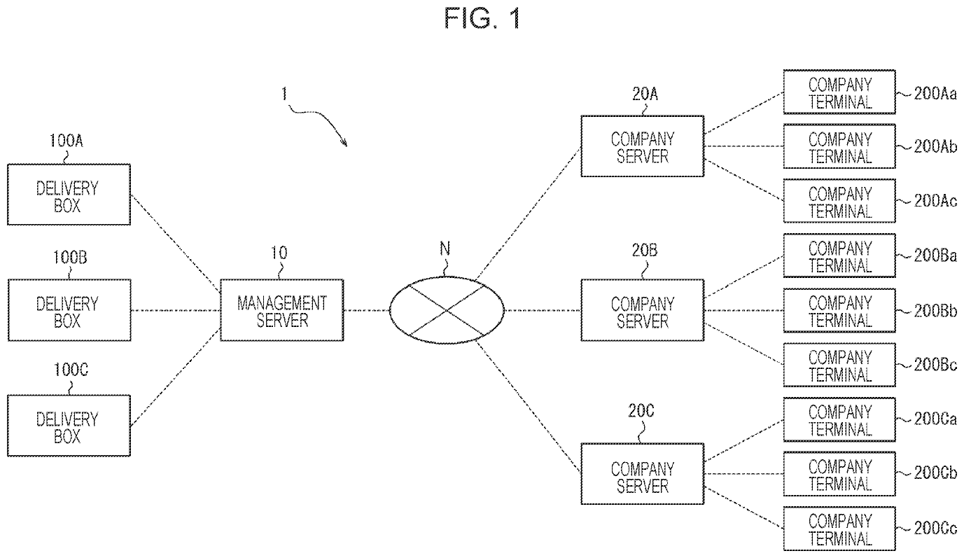

FIG. 1 is a diagram showing the configuration of the system according to one embodiment. As shown in FIG. 1, a system 1 according to one embodiment may be configured to include a management server 10 and company servers 20. As shown in FIG. 1, the management server 10 and the company servers 20 may be connected in a wired or wireless manner via a network N. As shown in FIG. 1, the system 1 according to one embodiment may include delivery boxes 100 and company terminals 200. In FIG. 1, a state where the elements are connectable in a wired or wireless manner is represented by dashed lines.

In the present disclosure, the “server” may be a computer that provides a service. In other words, the “server”, as in the case of, for example, a server in a client/server model, may be a computer and/or software that implements a function to provide information and/or processing results in response to a request from a client.

The management server 10 according to one embodiment is a server that manages and/or controls the delivery boxes 100. The management server 10 according to one embodiment may be a server operated by a delivery company that delivers packages to storage apparatuses such as the delivery boxes 100 (for example, if recipients are absent). On the other hand, the management server 10 according to one embodiment does not necessarily need to be operated by a delivery company. The management server 10 according to one embodiment may be, for example, a server operated by a company that provides a service for collectively managing delivery boxes of a plurality of delivery companies (including other companies in the same industry). The management server 10 may be, for example, a cloud server that provides a cloud service.

The management server 10 manages and/or controls at least one delivery box 100. In FIG. 1, the management server 10 is connected to a delivery box 100A, a delivery box 100B, and a delivery box 100C. The management server 10 may be connected in a wired or wireless manner to at least one, but any number of, delivery boxes 100. In the present disclosure, when a plurality of delivery boxes such as the delivery box 100A and the delivery box 100B are not distinguished from each other, the plurality of delivery boxes may be simply referred to as “delivery boxes 100”.

The delivery box 100 according to one embodiment may be, for example, a storage apparatus usable as a package delivery box, such as the above-described delivery box or a delivery locker. The delivery box 100 according to one embodiment may be, for example, an apparatus that stores a package, such as a commercial product delivered by a delivery company, such as a courier service company, until a recipient receives the package. In other words, if a recipient of a package, such as a delivered commercial product, is absent, for example, a delivery company, such as a courier service company, is able to store the package in the delivery box 100. A recipient of a package, such as a delivered commercial product, is able to take out the package, delivered while the recipient is, for example, absent, from the delivery box 100. As described above, one or more delivery box 100 are each managed and/or controlled by the management server 10. FIG. 1 shows the delivery boxes 100 such that the delivery boxes 100 are capable of connecting with the management server 10. However, the delivery boxes 100 may be, for example, configured to be capable of connecting with the management server 10 via the network N.

The management server 10 may be connected in a wired or wireless mariner to at least one company server 20 via the network N. In FIG. 1, the management server 10 is connected to a company server 20A, a company server 20B, and a company server 20C. The management server 10 may be connected in a wired or wireless manner to at least one, but any number of, company servers 20. In the present disclosure, when the plurality of company servers 20 such as the company server 20A and the company server 20B are not distinguished from each other, the plurality of company servers may be simply referred to as “company servers 20”.

The company server 20 according to one embodiment may be typically a server used by a staff member of a company that provides a delivery service, such as a courier service, or the like. For example, the company server 20A may be a server used by a staff member of Company A that is a company that provides a delivery service or the like. The company server 20B may be a server used by a staff member of Company B that is a company that provides a delivery service or the like. The company server 20C may be a server used by a staff member of Company C that is a company that provides a delivery service or the like.

The company server 20 sends, for example, various pieces of information on delivery of a package in response to a request. The company server 20 may generate and provide a delivery plan for packages that a delivery staff member takes charge of in response to, for example, a request from the staff member.

In FIG. 1, the company server 20A is connected to a company terminal 200Aa, a company terminal 200Ab, and a company terminal 200Ac. The company server 20B is connected to a company terminal 200Ba, a company terminal 200Bb, and a company terminal 200Bc. The company server 20C is connected to a company terminal 200Ca, a company terminal 200Cb, and a company terminal 200Cc. In this way, the company server 20A, the company server 20B, and the company server 20C each may be connected in a wired or wireless manner to at least one company terminal 200.

In the present disclosure, when a plurality of company terminals such as the company terminal 200Aa and the company terminal 200Ab is not distinguished from each other, the plurality of company terminals may be simply referred to as “company terminals 200A”. Similarly, in the present disclosure, when a plurality of company terminals such as the company terminal 200Ba and the company terminal 200Bb is not distinguished from each other, the plurality of company terminals may be simply referred to as “company terminals 200B”. Similarly, in the present disclosure, when a plurality of company terminals such as the company terminal 200Ca and the company terminal 200Cb is not distinguished from each other, the plurality of company terminals may be simply referred to as “company terminals 200C”. In the present disclosure, when a plurality of company terminals such as the company terminals 200A and the company terminals 200B is not distinguished from each other, the plurality of company terminals may be simply referred to as “company terminals 200”.

The company terminal 200 may be typically a terminal used by a staff member of a company that provides a delivery service, such as a courier service, or the like. For example, the company terminal 200A may be used by a staff member of Company A that is a company that provides a delivery service or the like. The company terminal 200B may be used by a staff member of Company B that is a company that provides a delivery service or the like. The company terminal 200C may be used by a staff member of Company C that is a company that provides a delivery service or the like.

The company terminal 200 according to one embodiment may be a terminal used by a staff member that picks up a package from a customer or delivers a package to a recipient, out of staff members of a company that provides a delivery service, such as a courier service, or the like. For example, the company terminal 200 may be a terminal with which a staff member of a company that provides a delivery service, such as a courier service, or the like inputs information on a delivery when receiving a request for delivery. For example, the company terminal 200 may be a code reader with the function of reading a two-dimensional code, such as a barcode or a QR code (registered trademark), or the like. The company terminal 200 may be, for example, a terminal, such as a car navigation system, used in a delivery vehicle in which a staff member of a company that provides a delivery service, such as a courier service, or the like, rides. Other than the above, the company terminal 200 may be one of various terminals capable of sending and/or receiving information subjected to an operation of a staff member of a company that provides a delivery service or the like. FIG. 1 shows that the company terminal 200 is capable of connecting with the company server 20. However, the company terminal 200 may be, for example, configured to be capable of connecting with the company server 20 via the network N.

The network N shown in FIG. 1 is made up of a wired network, a wireless network, or any appropriate combination of wired and wireless networks. The network N may be any appropriate network, such as the Internet or an intranet, as long as the network N enables the management server 10 and another electronic device, such as at least one of the company server 20 and the company terminal 200, to communicate with each other.

Next, the configuration of each of the management server 10, the delivery boxes 100, the company servers 20, and the company terminals 200, shown in FIG. 1, will be described in more details.

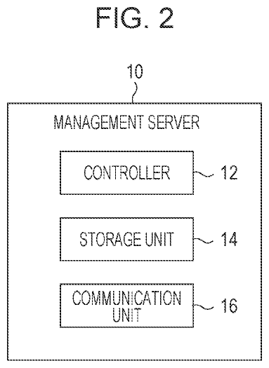

FIG. 2 is a functional block diagram schematically showing the configuration of the management server 10 according to one embodiment.

As shown in FIG. 2, the management server 10 according to one embodiment includes a controller 12, a storage unit 14, and a communication unit 16. The management server 10 according to one embodiment does not need to include one or some of the functional units shown in FIG. 2 or may include a functional unit other than those shown in FIG. 2.

The controller 12 executes various functions for controlling and/or managing the management server 10. The controller 12 may include at least one processor, such as a central processing unit (CPU), to provide controlling and processing capabilities to execute various functions. The controller 12 may implement the functions collectively by using one processor, or may implement the functions by using some processors, or may implement the functions by individual processors. A processor may be implemented as a single integrated circuit. An integrated circuit is also referred to as integrated circuit (IC). A processor may be implemented as a plurality of integrated circuits and discrete circuits connected to each other so as to be able to communicate with each other. A processor may be implemented in accordance with other various known techniques. In one embodiment, the controller 12 may be made up of, for example, a CPU and a program to run on the CPU. A program to run in the controller 12, a result of a process executed in the controller 12, and the like may be stored in the storage unit 14. The operation of the controller 12 of the management server 10 according to one embodiment will be further described later.

The storage unit 14 stores various pieces of information acquired from the controller 12, the communication unit 16, and the like. In one embodiment, the storage unit 14 may store information input by a user or the like. The storage unit 14 stores a program and the like to be executed by the controller 12. Additionally, the storage unit 14 also stores, for example, various data, such as results computed by the controller 12. The storage unit 14 may also include a work memory or the like that is used at the time when the controller 12 operates. The storage unit 14 may be made up of, for example, a semiconductor memory, a magnetic disk, or the like; however, the storage unit 14 is not limited thereto. The storage unit 14 may be any appropriate storage device. For example, the storage unit 14 may be a storage medium, such as a memory card inserted in the management server 10 according to one embodiment. The storage unit 14 may be an internal memory of a CPU that is used as the controller 12.

In one embodiment, the storage unit 14 may store first information indicating the home probability of a recipient of a package to be delivered. First information indicating the home probability of a recipient of a package to be delivered will be further described later.

The communication unit 16 is able to implement various functions including wireless communication. The communication unit 16 may implement communication compliant with various communication modes, such as long term evolution (LTE), 4G, and 5G. The communication unit 16 may include, for example, a modem of which the communication mode is standardized in International Telecommunication Union Telecommunication Standardization Sector (ITU-T). The communication unit 16 may implement wireless communication compliant with various modes, such as Wi-Fi and Bluetooth (registered trademark). The communication unit 16 may perform wireless communication via a network with, for example, a communication unit of an external device, such as an external server and a cloud server, via, for example, an antenna. In one embodiment, the communication unit 16 may receive various pieces of information from, for example, an external database, such as an external server and a cloud server. Information to be received by the communication unit 16 may be supplied to, for example, the controller 12 and/or the storage unit 14. Information to be sent from the communication unit 16 may be supplied from, for example, the controller 12 and/or the storage unit 14.

Various pieces of information to be sent or received by the communication unit 16 may be stored in, for example, the storage unit 14. The communication unit 16 may be configured to include, for example, an antenna that sends or receives radio waves, an adequate RF portion, and the like. The communication unit 16 can be configured by using a known technique for wireless communication. The communication unit 16 may be an interface for the management server 10 to perform wired communication with another electronic device.

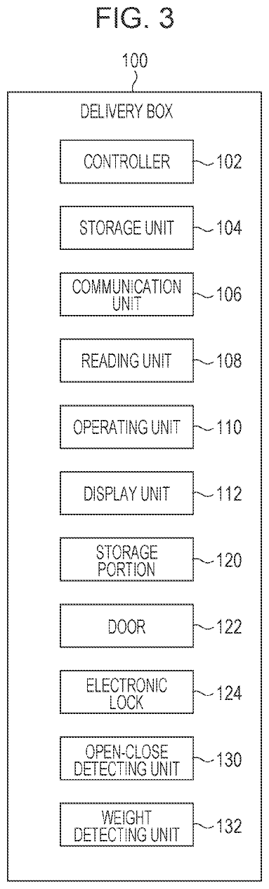

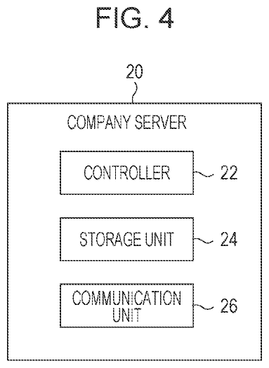

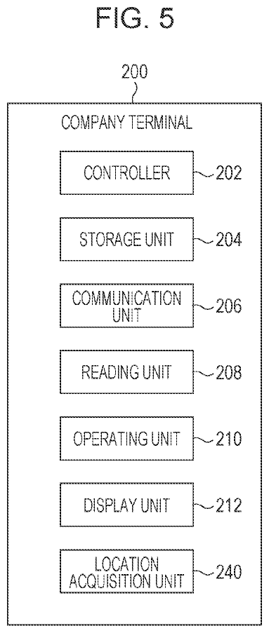

In one embodiment, the communication unit 16 of the management server 10 shown in FIG. 2 may communicate in a wired or wireless manner with a communication unit 106 (FIG. 3) of the delivery box 100. The communication unit 16 may communicate in a wired or wireless manner with a communication unit 26 (FIG. 4) of the company server 20. The communication unit 16 may communicate in a wired or wireless manner with a communication unit 206 (FIG. 5) of the company terminal 200. The communication unit 16 may communicate in a wired or wireless manner with at least one of the communication unit 26 of the company server 20 and the communication unit 206 of the company terminal 200. In this way, in one embodiment, the communication unit 16 communicates with, for example, a storage apparatus, such as the delivery box 100, and another electronic device, such as at least one of the company server 20 and the company terminal 200. The communication unit 16 may, for example, wirelessly communicate with a communication unit of another electronic device, such as an information processing apparatus that functions as an external server.

The management server 10 according to one embodiment may have a hardware configuration similar to a server in a general client-server model. As described above, the management server 10 according to one embodiment may be, for example, a cloud server that provides a cloud service.

FIG. 3 is a functional block diagram schematically showing the configuration of the delivery box 100 according to one embodiment.

As shown in FIG. 3, the delivery box 100 according to one embodiment includes a controller 102, a storage unit 104, and the communication unit 106. The delivery box 100 according to one embodiment may include a reading unit 108, an operating unit 110, and a display unit 112. The delivery box 100 according to one embodiment may include a storage portion 120, a door 122, an electronic lock 124, an open-close detecting unit 130, and a weight detecting unit 132. The delivery box 100 according to one embodiment does not need to include one or some of the functional units shown in FIG. 3 or may include a functional unit other than those shown in FIG. 3.

The controller 102 executes various functions for controlling and/or managing the delivery box 100. The controller 102 may be configured as in the case of, for example, the controller 12 shown in FIG. 2.

The storage unit 104 stores various pieces of information acquired from the controller 102, the communication unit 106, and the like. The storage unit 104 stores a program and the like to be executed by the controller 102. Additionally, the storage unit 104 also stores, for example, various data, such as results computed by the controller 102. The storage unit 104 may be configured as in the case of, for example, the storage unit 14 shown in FIG. 2.

The communication unit 106 may communicate with the communication unit 16 of the management server 10 shown in FIG. 2. In this case, the communication unit 106 may communicate with the communication unit 16 of the management server 10 via the network N. The communication unit 106 may be configured as in the case of, for example, the communication unit 16 shown in FIG. 2.

The reading unit 108 may be made up of, for example, a barcode reader, a camera, and/or the like for reading information for identifying a recipient who receives a package stored in the delivery box 100. In this case, a camera may be made up of one of various imaging devices, such as a CCD image sensor. In one embodiment, a recipient who receives a package stored in the delivery box 100 may place an identification image, such as a one-dimensional barcode and a QR code (registered trademark), displayed on the display unit of a recipient terminal, such as a smartphone, over the reading unit 108. In this case, the delivery box 100 may authenticate whether the recipient is a regular person to receive the package stored in the delivery box 100 by authenticating the identification image, such as a one-dimensional barcode and a QR code (registered trademark).

When the recipient of the package is authenticated as the regular person, the delivery box 100 may release the electronic lock 124 of the door 122. When a recipient of a package is not authenticated as the regular person, the delivery box 100 may be configured not to release the electronic lock 124 of the door 122. In this way, only the regular recipient is allowed to receive the package stored in the delivery box 100. In one embodiment, an identification image to be read by the reading unit 108 is not limited to a one-dimensional code, such as a barcode, or a two-dimensional code, such as a QR code (registered trademark), and may be any appropriate identification image. In one embodiment, identification information to be read by the reading unit 108 is not limited to image information and may be any appropriate information, such as a character and a passcode composed of a character string. The reading unit 108 is not limited to the functional unit, such as a barcode reader and/or a camera, and may be, for example, an RFID reader that reads identification information from an RF tag or another functional unit. Information read by the reading unit 108 may be supplied to, for example, the controller 102, the storage unit 104, and/or the like.

The operating unit 110 detects, for example, operation performed by a user, such as a recipient or a package and a staff member of a delivery company, as input. The operating unit 110 may be made up of, for example, an input device, such as a keyboard. The operating unit 110 may be, for example, any appropriate input device used by a user to perform operation, such as keys (physical keys) like a keyboard, a button (physical button), a switch (mechanical switch), and/or a pointing device, such as a mouse and a trackball. In one embodiment, the operating unit 110 may be one of various known input devices. An operation signal (input signal) detected by the operating unit 110 may be supplied to, for example, the controller 102, the storage unit 104, and/or the like.

The operating unit 110 may be an input device, such as a touch panel and a touch sensor. In this case, the operating unit 110 may adopt a touch panel of various types, such as a resistive film type, a capacitive type, and an optical type.

The display unit 112 may be, for example, any appropriate display device, such as a liquid crystal display, an organic EL display (organic electro-luminescence panel), and an inorganic EL display (inorganic electro-luminescence panel). The display unit 112 may display various pieces of information, such as text, graphics, and symbols. The display unit 112 may display objects, icon images, and the like that compose various GUIs, including a pointer, to prompt a user who operates the delivery box 100 to perform operation. Various data required to perform display on the display unit 112 may be supplied from, for example, the controller 102, the storage unit 104, or the like. The display unit 112 may be made up of a backlight or the like as needed.

The delivery box 100 according to one embodiment may include a speaker or the like that conveys various pieces of information via voice to a user who operates the delivery box 100, instead of the display unit 112 or in addition to the display unit 112.

In one embodiment, the display unit 112 may be made up of, for example, a touch screen display together with the operating unit 110. In this case, a touch screen display may include, for example, a display device, such as a liquid crystal display and an organic EL display, as the display unit 112. In this case, a touch screen display may include, for example, a touch sensor or a touch panel that detects whether a user is touching and the location of the touch as the operating unit 110. With such a configuration, for example, keys, such as a numeric keypad, an icon, or the like is displayed on the display unit 112 as an object, and operation that an operator (user) touches the object can be detected by the operating unit 110.

The storage portion 120 is a space capable of storing a package delivered to a recipient in the delivery box 100. In other words, when a staff member of a delivery company delivers a package to the address of a recipient, the staff member is able to store the package in the storage portion 120 of the delivery box 100 if the recipient is absent. The storage portion 120 may be, for example, a component of the casing of the delivery box 100. When the delivery box 100 is, for example, installed at the entrance or the like of a collective housing, such as an apartment house and a condominium, the delivery box 100 may be configured to include a plurality of the storage portions 120.

The door 122 may be attached to a location where a package stored in the storage portion 120 is taken in and out. The door 122 may be configured to be capable of opening or closing at least part of the storage portion 120. When the door 122 is configured to open at the delivery box 100, a recipient of a package stored in the delivery box 100 is able to take out the package. When the door 122 is configured to close, it is possible to prevent, for example, a person other than a recipient from taking out a package stored in the delivery box 100 until the recipient takes out the package. When the delivery box 100 includes a plurality of the storage portions 120, the door 122 may be attached for each of the storage portions 120.

The door 122 may be configured to automatically open or close by, for example, control of the controller 102. The door 122 may be configured to manually open or close by, for example, a user.

The electronic lock 124 is capable of locking up or releasing the lock in a state where the door 122 is closed. The electronic lock 124 may, for example, electronically lock up the door 122. In one embodiment, the electronic lock 124 may selectively lock up or release at least any one of the locks of the plurality of doors 122. In this case, the controller 102 may control lock-up and release of the electronic lock 124. When the delivery box 100 includes a plurality of storage portions 120, the electronic lock 124 may be attached for each of the doors 122 of the storage portions 120.

At least any one of the storage portion 120, the door 122, and the electronic lock 124 shown in FIG. 3 may be configured similarly to a package delivery box, such as an existing delivery box and a delivery locker.

The open-close detecting unit 130 may be a sensor that detects whether the door 122 is closed or open. For example, the open-close detecting unit 130 may be a sensor that detects the presence of a contact between the contacts of the door 122 and storage portion 120. In this case, when the contacts of the door 122 and storage portion 120 are in contact with each other, the open-close detecting unit 130 is able to detect that the door 122 is closed. On the other hand, when the contacts of the door 122 and storage portion 120 are not in contact with each other, the open-close detecting unit 130 is able to detect that the door 122 open. The open-close detecting unit 130 may be a sensor that detects whether the electronic lock 124 is in a lock-up state or in a released state. In this case, the open-close detecting unit 130 may determine whether the electronic lock 124 is in a lock-up state or in a released state in accordance with, for example, a status signal of the electronic lock 124. A signal based on a result detected by the open-close detecting unit 130 may be supplied to, for example, the controller 102, the storage unit 104, and/or the like.

The weight detecting unit 132 may be a sensor that detects the weight of a package stored in the storage portion 120. The weight detecting unit 132 may be a sensor that detects the weight of a package stored in the storage portion 120 with high accuracy. The weight detecting unit 132 may be a sensor that detects the weight of a package stored in the storage portion 120 with low accuracy. In one embodiment, it is sufficient that the weight detecting unit 132 is capable of detecting the weight of a package with an accuracy to such an extent that whether a package is stored n the storage portion 120 can be determined. When the eight detecting unit 132 has detected a certain weight inside the storage portion 120, it may be determined that a package is stored in the storage portion 120. On the other hand, when the weight detecting unit 132 has not detected a certain weight inside the storage portion 120 (as in the case where, for example, the weight is substantially zero), it may be determined that no package is stored in the storage portion 120.

The weight detecting unit 132 determines whether a package is stored in the storage portion 120 in accordance with the detected weight of a package. In one embodiment, instead of the weight detecting unit 132, for example, an imaging device, such as a camera, may be used to determine whether a package is stored in the storage portion 120. A signal based on a result detected by the weight detecting unit 132 may be supplied to, for example, the controller 102, the storage unit 104, and/or the like.

Depending on the configuration of the delivery box 100, the delivery box 100 may be configured to include, for example, only one of the open-close detecting unit 130 and the weight detecting unit 132 or may be configured not to include both of them.

FIG. 4 is a functional block diagram schematically showing the configuration of the company server 20 according to one embodiment.

As shown in FIG. 4, the company server 20 according to one embodiment includes a controller 22, a storage unit 24, and the communication unit 26. The company server 20 according to one embodiment does not need to include one or some of the functional units shown in FIG. 4 or may include a functional unit other than those shown in FIG. 4. As described above, the company server 20 may be typically a server used by a staff member of a company that provides a delivery service, such as a courier service, or the like.

The controller 22 executes various functions for controlling and/or managing the company server 20. The controller 22 may be configured as in the case of, for example, the controller 12 shown in FIG. 2.

The storage unit 24 stores various pieces of information acquired from the controller 22, the communication unit 26, and the like. The storage unit 24 stores a program and the like to be executed by the controller 22. Additionally, the storage unit 24 also stores, for example, various data, such as results computed by the controller 22. The storage unit 24 may be configured as in the case of, for example, the storage unit 14 shown in FIG. 2.

The communication unit 26 may communicate in a wired or wireless manner with the communication unit 16 of the management server 10 shown in FIG. 2. In this case, the communication unit 26 may communicate with the communication unit 16 of the management server 10 via the network N. The communication unit 26 may communicate in a wired or wireless manner with the communication unit 206 (FIG. 5) of the company terminal 200. In this case, the communication unit 26 may communicate with the communication unit 206 of the company terminal 200 via the network N. The communication unit 26 may be configured as in the case of, for example, the communication unit 16 shown in FIG. 2.

In this way, the company server 20 according to one embodiment may have a hardware configuration similar to a server in a general client-server model. The company server 20 according to one embodiment may be, for example, a cloud server that provides a cloud service.

FIG. 5 is a functional block diagram schematically showing the configuration of the company terminal 200 according to one embodiment.

As shown in FIG. 5, the company terminal 200 according to one embodiment includes a controller 202, a storage unit 204, and the communication unit 206. The company terminal 200 according to one embodiment may include a reading unit 208, an operating unit 210, and a display unit 212. The company terminal 200 according to one embodiment may include a location acquisition unit 240. The company terminal 200 according to one embodiment does not need to include one or some of the functional units shown in FIG. 5 or may include a functional unit other than those shown in FIG. 5.

The controller 202 executes various functions for controlling and/or managing the company terminal 200. The controller 202 may be configured as in the case of, for example, the controller 12 shown in FIG. 2.

The storage unit 204 stores various pieces of information acquired from the controller 202, the communication unit 206, and the like. The storage unit 204 stores a program and the like to be executed by the controller 202. Additionally, the storage unit 204 also stores, for example, various data, such as results computed by the controller 202. The storage unit 204 may be configured as in the case of, for example, the storage unit 14 shown in FIG. 2.

The communication unit 206 may communicate in a wired or wireless manner with the communication unit 26 of the company server 20 shown in FIG. 3. In this case, the communication unit 206 may communicate with the communication unit 26 of the company server 20 via the network N. The communication unit 206 may communicate in a wired or wireless manner with the communication unit 16 of the management server 10 shown in FIG. 2. In this case, the communication unit 206 may communicate with the communication unit 16 of the management server 10 via the network N. The communication unit 206 may be configured as in the case of, for example, the communication unit 16 shown in FIG. 2.

The reading unit 208 may be made up of, for example, a barcode reader, a camera, and/or the like for reading information for identifying a package to be delivered by a delivery company. In this case, a camera may be made up of one of various imaging devices, such as a CCD image sensor. In one embodiment, a staff member of a delivery company (for example, a driver of a delivery vehicle) or the like may place an identification sign, such as a one-dimensional barcode and a QR code (registered trademark), shown on a slip or the like attached to a package to be delivered, over the reading unit 208. In this case, the company terminal 200 is capable of referencing information associated with an identification sign, such as a one-dimensional barcode and a QR code (registered trademark), by, for example, identifying the identification sign. The company terminal 200 is capable of associating other information with an identification sign, such as a one-dimensional barcode and a QR code (registered trademark), by, for example, identifying the identification sign. Other information to be associated with the identification sign may be, for example, information indicating at least any one of the name of a client who makes a request to deliver a package, the address and recipient of a package to be delivered, a desired date and time to deliver a package, the contents of a package to be delivered, and the like.

In one embodiment, an identification sign to be read by the reading unit 208 is not limited to a one-dimensional code, such as a barcode, or a two-dimensional code, such as a QR code (registered trademark), and may be any appropriate identification information. In one embodiment, identification information to be read by the reading unit 208 is not limited to image information and may be any appropriate information, such as a character and a passcode composed of a character string. The reading unit 208 is not limited to the functional unit, such as a barcode reader and/or a camera, and may be, for example, an RFID reader that reads identification information from an RF tag or another functional unit. Information read by the reading unit 208 may be supplied to, for example, the controller 202, the storage unit 204, and/or the like.

As described above, in one embodiment, the company terminal 200 may be a terminal, such as a car navigation system, used in a delivery vehicle in which a staff member of a company that provides, for example, a delivery service, such as a courier service, or the like, rides. In this case, the company terminal 200 configured as a terminal, such as a car navigation system, does not need to include the reading unit 208. A staff member in this case may further carry another company terminal 200. Another company terminal 200 carried by a staff member may include the reading unit 208.

The operating unit 210 detects, for example, operation performed by a user, such as a staff member of a delivery company, as input. The operating unit 210 may be made up of, for example, an input device, such as a keyboard. The operating unit 210 may be, for example, any appropriate input device used by a user to perform operation, such as keys (physical keys) like a keyboard, a button (physical button), a switch (mechanical switch), and/or a pointing device, such as a mouse and a trackball. In one embodiment, the operating unit 210 may be one of various known input devices. An operation signal (input signal) detected by the operating unit 210 may be supplied to, for example, the controller 202, the storage unit 204, and/or the like.

The operating unit 210 may be an input device, such as a touch panel and a touch sensor. In this case, the operating unit 210 may adopt a touch panel of various types, such as a resistive film type, a capacitive type, and an optical type.

The display unit 212 may be, for example, any appropriate display device, such as a liquid crystal display, an organic EL display (organic electro-luminescence panel), and an inorganic EL display (inorganic electro-luminescence panel). The display unit 212 may display various pieces of information, such as text, graphics, and symbols. The display unit 212 may display objects, icon images, and the like that compose various GUIs, inducing a pointer, to prompt a user who operates the company terminal 200 to perform operation. Various data required to perform display on the display unit 212 may be supplied from, for example, the controller 202, the storage unit 204, or the like. The display unit 212 may be made up of a backlight or the like as needed.

The company terminal 200 according to one embodiment may include a speaker or the like that conveys various pieces of information via voice to a user who operates the company terminal 200, instead of the display unit 212 or in addition to the display unit 212.

In one embodiment, the display unit 212 may be made up of, for example, a touch screen display together with the operating unit 210. In this case, a touch screen display may include, for example, a display device, such as a liquid crystal display and an organic EL display, as the display unit 212. In this case, a touch screen display may include, for example, a touch sensor or a touch panel that detects whether a user is touching and the location of the touch as the operating unit 210. With such a configuration, for example, keys, such as a numeric keypad, an icon, or the like is displayed on the display unit 212 as an object, and operation that an operator touches the object can be detected by the operating unit 210. In one embodiment, the display unit 212 may display first information (described later) (information indicating the home probability of a recipient of a package) and second information (described later) (information indicating the availability of a storage apparatus, such as the delivery box 100).

The location acquisition unit 240 acquires information on the location of the company terminal 200. In one embodiment, the location acquisition unit 240 may acquire information on the location of a delivery vehicle on which the company terminal 200 is installed. Information on the location of the company terminal 200, detected by the location acquisition unit 240, may be supplied to, for example, the controller 202, the storage unit 204, and/or the like.

The location acquisition unit 240 may acquire location information in accordance with a global navigation satellite system (GNSS) technology or the like. The GNSS technology may include, for example, a satellite positioning system of any one of global positioning system (GPS), GLONASS, Galileo, quasi-zenith satellite system (QZSS), and the like. The location acquisition unit 240 may be, for example, a location information acquisition device, such as a GPS module. The location acquisition unit 240 is not limited to a GPS module or the like and may be made up of any appropriate device capable of acquiring information on the location.

Location information to be acquired by the location acquisition unit 240 may include, for example, information that is at least one of latitude information, longitude information, and altitude information. Location information to be acquired by the location acquisition unit 240 is supplied to the controller 202 and/or the storage unit 204. The controller 202 is able to grasp the current location and the like of the company terminal 200 in accordance with location information supplied from the location acquisition unit 240.

The company terminal 200 does not need to include a mechanism such as a GPS system that acquires its own location. In this case, the company terminal 200 may acquire the location of the company terminal 200 from a location acquisition unit, such as a GPS system included in another electronic device, such as a smartphone and a cellular phone, which cooperates with the company terminal 200 through, for example, the communication unit 206 or the like.

The company terminal 200 may acquire the location of the company terminal 200 from, for example, a location acquisition unit, such as a GPS system included in a delivery vehicle in which a staff member of a company that provides a delivery service, such as a courier service, or the like, rides.

A server (the management server 10) according to one embodiment may be capable of connecting in a wired or wireless manner to a storage apparatus (the delivery box 100) that stores a package delivered to a recipient, and another electronic device (the company server 20 or the company terminal 200). The communication unit 206 of the company terminal 200 may directly or indirectly communicate with (the communication unit 106 of) a storage apparatus, such as the delivery box 100.

Next, the operation of the system 1 including the management server 10 according to one embodiment will be further described. The system 1 including the management server 10 according to one embodiment can be used in various scenes where a delivery company or the like provides a service on delivery.

In the following description, an operation mainly performed by the management server 10 may be performed by control of the controller 12 of the management server 10. In other words, the operation “performed by the management server 10” may be an operation “performed by control of the controller 12”. “Storing or recording” by the management server 10 may be storing or recording by the storage unit 14 of the management server 10. Furthermore, “sending or receiving” by the management server 10 may be sending or receiving by the communication unit 16 of the management server 10.

Similarly, an operation mainly performed by the delivery box 100 may be performed by control of the controller 102 of the delivery box 100. In other words, the operation “performed by the delivery box 100” may be an operation “performed by control of the controller 102”. “Storing or recording” by the delivery box 100 may be storing or recording by the storage unit 104 of the delivery box 100. Furthermore, “sending or receiving” by the delivery box 100 may be sending or receiving by the communication unit 106 of the delivery box 100.

Similarly, an operation mainly performed by the company server 20 may be performed by control of the controller 22 of the company server 20. In other words, the operation “performed by the company server 20” may be an operation “performed by control of the controller 22”. “Storing or recording” by the company server 20 may be storing or recording by the storage unit 24 of the company server 20. Furthermore, “sending or receiving” by the company server 20 may be sending or receiving by the communication unit 26 of the company server 20.

Similarly, an operation mainly performed by the company terminal 200 may be performed by control of the controller 202 of the company terminal 200. In other words, the operation “performed by the company terminal 200” may be an operation “performed by control of the controller 202”. “Storing or recording” by the company terminal 200 may be storing or recording by the storage unit 204 of the company terminal 200. Furthermore, “sending or receiving” by the company terminal 200 may be sending or receiving by the communication unit 206 of the company terminal 200.

(Information Indicating Home Probability of Recipient of Package (First Information))

Initially, an operation that the management server 10 returns the home probability of a recipient of a package in response to a request from the company terminal 200 or the company server 20 will be described as an operation in the system 1. Here, the home probability of a recipient of a package is information indicating a probability at which a recipient of a package is estimated to be home at time to deliver the package as alp index for determining whether the recipient is home. Hereinafter, information indicating the home probability of a recipient of a package to be delivered is also referred to as “first information”.

In one embodiment, the management server 10 indirectly calculates a probability at which a recipient of a package is estimated to be home in accordance with a past history without directly inquiring about whether the recipient of the package is actually home. Therefore, the management server 10 is able to calculate a probability at which a recipient is home in accordance with information that takes the privacy of the recipient of the package into consideration.

Even when a person who lives in a building in which the delivery box 100 is installed is not able to receive a package due to, for example, a reason, such as absence, at the time when the package is delivered, the delivered package is able to be stored in the delivery box 100. In this case, the recipient of the package is able to receive the delivered package by taking out the package stored in the delivery box 100, for example, when the recipient arrives home.

Here, the action that a recipient of a package takes out the package from the delivery box 100 at home means that the recipient is estimated to be almost home (or going home) at least at that timing. In other words, at that timing, the home probability of the recipient is estimated to be considerably high.

In addition, after a recipient of a package takes out the package from the delivery box 100, the recipient is estimated to bring the package to his or her room. In addition, after a recipient of a package takes out the package from the delivery box 100, the recipient is estimated to open the package in his or her room. In other words, after a recipient of a package takes out the package from the delivery box 100, the home probability of the recipient is estimated to be not so low at least during a certain period of time.

However, after a considerable period of time has elapsed from when a recipient of a package takes out the package from the delivery box 100, the recipient is estimated to be absent due to, for example, going out again. In other words, after a relatively long period of time has elapsed from when a recipient of a package takes out the package from the delivery box 100, the home probability of the recipient is estimated to be not so high. Furthermore, as a period of time from when a recipient of a package takes out the package from the delivery box 100 extends, the home probability of the recipient is estimated to decrease. During a period of time from when a package is stored in the delivery box 100 to when a recipient takes out the package, the home probability of the recipient may be estimated to be relatively low on the assumption that the recipient is absent.

To calculate a home probability in the above-described way, the management server 10 may acquire, from the delivery box 100, a timing at which a recipient takes out a delivered package from the delivery box 100, together with information on the recipient. The management server 10 may set the timing at which a recipient takes out a delivered package from the delivery box 100 to a peak value of the home probability of the recipient. The peak value of the home probability of a recipient may be, for example, any appropriate relatively high probability adequate as a peak value, such as 100% and 95%. Furthermore, the management server 10 may gradually decrease the home probability of a recipient of a package each time a period of time elapses from a point in time at which the recipient takes out the package from the delivery box 100. For example, the management server 10 may set such that the home probability of a recipient reduces by 10% each time 15 minutes elapses from a point in time at which the recipient takes out a package from the delivery box 100.

In this way, in one embodiment, the communication unit 16 may receive, from the delivery box 100, information indicating time at which a package stored in the delivery box 100 is taken out by a recipient of the package. In this case, the controller 12 may determine the home probability of a recipient of a package in accordance with time indicated by information received by the communication unit 16. In one embodiment, the controller 12 may determine the home probability such that the home probability of a recipient is at the peak at time at which a package stored in the delivery box 100 is taken out by the recipient and the home probability of the recipient gradually decreases after that time.

The management server 10 may set the home probability of a recipient to, for example, a relatively high predetermined probability, such as 70% and 80%, until a predetermined period of time elapses from when the recipient takes out a delivered package from the delivery box 100. Here, a predetermined period of time may be, for example, any appropriate period of time, such as about 30 minutes and about one hour.

In this way, in one embodiment, the controller 12 may determine the home probability such that the home probability of a recipient is higher than or equal to a predetermined probability during a predetermined period of time from time at which a package stored in the delivery box 100 is taken out by the recipient of the package.

The management server 10 may set the home probability such that the home probability of a recipient is, for example, a relatively low predetermined probability, such as 5% and 15%, during a period of time from a point in time at which a package is stored in the delivery box 100 to a point in time at which the package is taken out by the recipient.

In this way, in one embodiment, the controller 12 may determine the home probability such that the home probability of a recipient is lower than or equal to a predetermined probability during a period of time until a package stored in the delivery box 100 is taken out by the recipient.

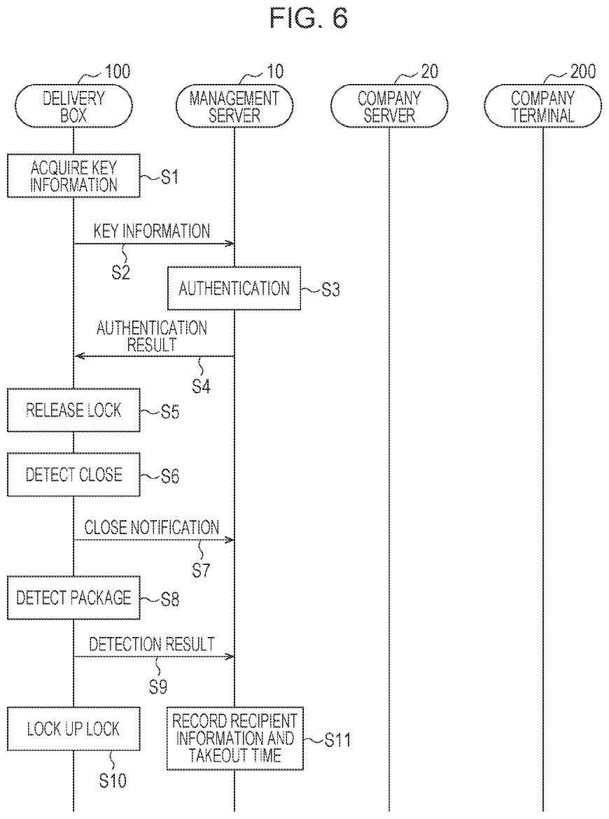

FIG. 6 is a diagram Illustrating an example of an operation that the management server 10 generates information indicating the home probability of a recipient of a package in the system 1. FIG. 6 shows the sequence of operations of elements included in the system 1 sequentially from above in time sequence. As shown in FIG. 6, the elements included in the system 1 may include the delivery box 100, the management server 10, the company server 20, and the company terminal 200.

The time when the operation shown in FIG. 6 starts may be a scene where a recipient intends to take out a package stored in the delivery box 100. At this time, the recipient of the package may input key information to the delivery box 100 to release the electronic lock 124 of the delivery box 100 in which the package is stored. Here, key information is assumed to be provided to a regular recipient when applying for a service for using the delivery box 100 and is also assumed to be recorded in the management server 10 of the delivery box 100. Key information may be, for example, information recorded in a card key owned by a recipient. In this case, the recipient is able to place the card key over the reading unit 108 and cause the delivery box 100 to read key information. Key information may be, for example, an authentication image, such as a barcode and a QR code (registered trademark), displayed on the screen of a mobile terminal, such as a smartphone owned by a recipient. In this case, the recipient is able to cause the delivery box 100 to read key information by placing the authentication image displayed on the screen of the mobile terminal over the reading unit 108.

The operation shown in FIG. 6 may be started at a point in time at which a recipient who desires to take out a package stored in the delivery box 100 inputs key information to the delivery box 100.

When a recipient inputs key information to the delivery box 100, the delivery box 100 acquires the key information (step S1). When the delivery box 100 acquires the key information in step S1, the delivery box 100 sends the acquired key information to the management server 10 (step S2).

When the management server 10 receives the key information in step S2, the management server 10 authenticates the recipient by comparing the received key information with prerecorded information on a regular recipient (step S3). When the recipient is authenticated in step S3, the management server 10 sends the result of the authentication to the delivery box 100 (step S4).

When it is approved in step S4 that the recipient is a regular recipient, the delivery box 100 releases the electronic lock 124 of the door 122 of the storage portion 120 in which a package of the recipient is stored (step S5). When it is not approved in step S4 that the recipient is a regular recipient, the delivery box 100 does not need to release the electronic lock 124 of the door 122 of the storage portion 120 in step S5.

When the electronic lock 124 is released in step S5, the delivery box 100 detects that the door 122 is closed (step S6). In step S6, the delivery box 100 may determine that the door 122 is closed from the result detected by the open-close detecting unit 130. When the door 122 is closed in step S6, the delivery box 100 may provide the management server 10 with notification that the door 122 is closed (step S7).

When notification that the door 122 is closed is provided in step S7, the delivery box 100 detects whether the package is still inside the storage portion 120 (step S8). In step S8, the delivery box 100 may determine whether there is a package in the storage portion 120 from, for example, the result detected by the weight detecting unit 132. When it is detected in step S8 that no package is in the storage portion 120, the delivery box 100 sends the detected result to the management server 10 (step S9). After step S9, the delivery box 100 may lock up the electronic lock 124 of the door 122 of the storage portion 120 from which the package is taken out (step S10).

In addition, after step S9, the management server 10 records time at which the recipient takes out the package from the delivery box 100 together with recipient information (step S11). In step S11, the management server 10 may set time at which the recipient takes out the package to a point in time at which the door 122 is closed (step S7) or to a point in time at which notification that no package is in the storage portion is provided (step S9).

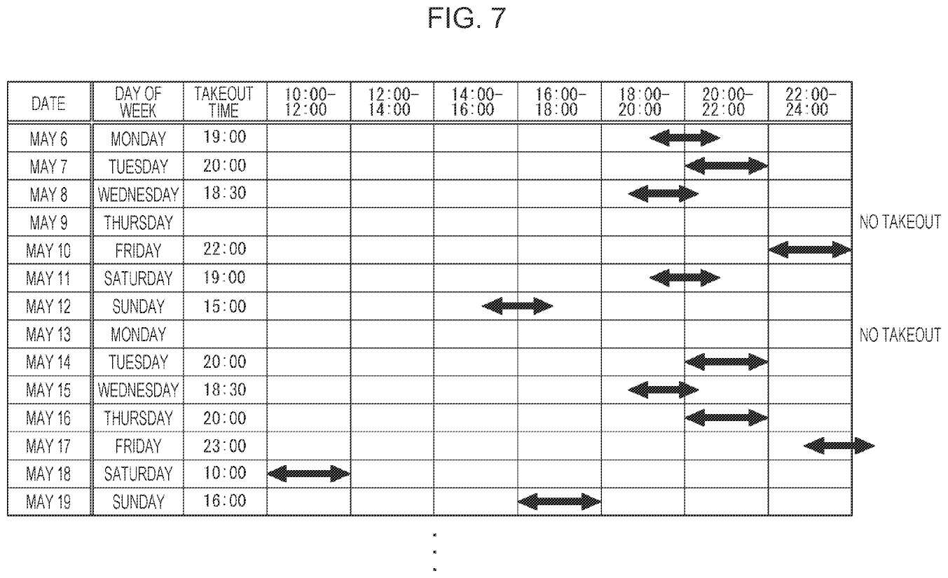

FIG. 7 is a table showing an example of results obtained by performing the operation of FIG. 6 on a specific recipient (for example, referred to as recipient X) by using the system 1. FIG. 7 conceptually shows information stored in the storage unit 14 of the management server 10 by performing the operation shown in FIG. 6. Here, for the sake of description, it is assumed that recipient X uses the delivery box 100 at a high frequency, that is, recipient X uses package delivery at a high frequency.

As shown in FIG. 7, it is assumed that the management server 10 records that recipient X has taken out at 19:00 a package delivered during absence on May 6. It is assumed that the management server 10 records that recipient X has taken out at 20:00 a package delivered during absence on May 7. It is assumed that the management server 10 records that recipient X has taken out at 18:30 a package delivered during absence on May 8.

It is assumed that the management server 10 records that a package has not been taken out on May 9. As a case where a package is not taken out, a case where a package is not delivered or a case where a package is delivered but recipient X has not received within that day is imagined. However, the management server 10 is assumed to be able to grasp whether a package is delivered to a specific delivery box 100 by acquiring information on delivery from the company server 20. For this reason, for the case where a package is not delivered, the management server 10 avoids setting the home probability of recipient X to a low probability on the assumption that the recipient has not received the package.

In the example shown in FIG. 7, it is assumed that the home probability of the recipient is high for about two hours from when recipient X receives a package. In other words, time periods with arrows in FIG. 7 indicate periods of time during which the home probability of recipient X is relatively high. Time periods with no arrows in FIG. 7 Indicate periods of time during which the home probability of recipient X is relatively low or periods of time during which there is no information on home probability. Therefore, a delivery company is able to increase the probability that the delivery company is able to deliver a package and directly hand the package while the recipient is home by performing a delivery during periods of time during which the home probability of a specific recipient is high.

By repeating the above-described operation, the management server 10 is able to increase the accuracy of the home probability of a specific recipient. For example, by accumulating information on home probability as shown in FIG. 7 in the storage unit 14, the management server 10 is able to obtain various home probabilities of a specific recipient, for example, by time period, by morning or afternoon, by day of week, by date, by month, by season, or the like. For example, the management server 10 is able to make a determination, such as a determination that the home probability of a recipient is relatively high in the morning of Wednesday, a determination that the home probability of a recipient is relatively high in the afternoon in the second half of each of odd-numbered months, and a determination that the home probability of a recipient is relatively low in a specific season.

In this way, in one embodiment, the controller 12 may determine the home probability of a recipient of a package to be delivered in a predetermined time frame in accordance with first information stored in the storage unit 14.

In the example shown in FIG. 6 and FIG. 7, the management server 10 determines the home probability of a recipient in accordance with time at which the recipient takes out a package stored in the delivery box 100. In one embodiment, the management server 10 may determine the home probability of a recipient in accordance with information other than time at which the recipient takes out a package.

For example, it is assumed that a recipient at home directly receives a package at the time when a courier delivers the package to the home of the recipient. In this case, at a point in time at which the recipient receives the delivered package, it may be assumed that the home probability of the recipient is high. For example, the company terminal 200 used by a staff member of a courier may record time at which a handover of a package to a recipient is complete. Time at which a handover of a package to a recipient is complete may be, for example, a point in time at which, after a package is handed over to a recipient, a slip attached to the package is processed by the company terminal 200. Here, processing a slip with the company terminal 200 may be reading an identification sign, such as a barcode and a QR code (registered trademark), attached to a slip of a delivered package with the reading unit 208 of the company terminal 200. The company terminal 200 may send, to the company server 20, information on time at which a handover of the package to the recipient is complete. When the management server 10 receives information on time from the company server 20 or the company terminal 200, the management server 10 is able to determine the home probability of the recipient in accordance with the time.

In this way, in one embodiment, the communication unit 16 may receive information indicating time at which a delivered package is received by a recipient from, for example, another electronic device, such as the company server 20 and the company terminal 200. In this case, the controller 12 may determine the home probability of the recipient in accordance with the time.

For example, if a recipient is absent at the time when a courier delivers a package, the courier is able to leave a delivery notice in a mailbox or the like of the home of the recipient. Then, the recipient coming home is informed of the delivery of the package from the delivery notice and may make a redelivery request to the delivery company. In this case, it may be assumed that the home probability of the recipient is high at time specified at the time of a request for redelivery. For example, the company server 20 may record time requested from the recipient for redelivery. When the management server 10 receives information on time from the company server 20, the management server 10 is able to determine the home probability of a recipient in accordance with the time.

In this way, in one embodiment, the communication unit 16 may receive information indicating time specified by a recipient of a delivered package from, for example, another electronic device, such as the company server 20 (or the company terminal 200). In this case, the controller 12 may determine the home probability of the recipient in accordance with the time.

Next, an operation that the management server 10 returns the home probability of a specific recipient in response to a request from a delivery company that needs to be informed of the home probability of the recipient will be described as an operation in the system 1.

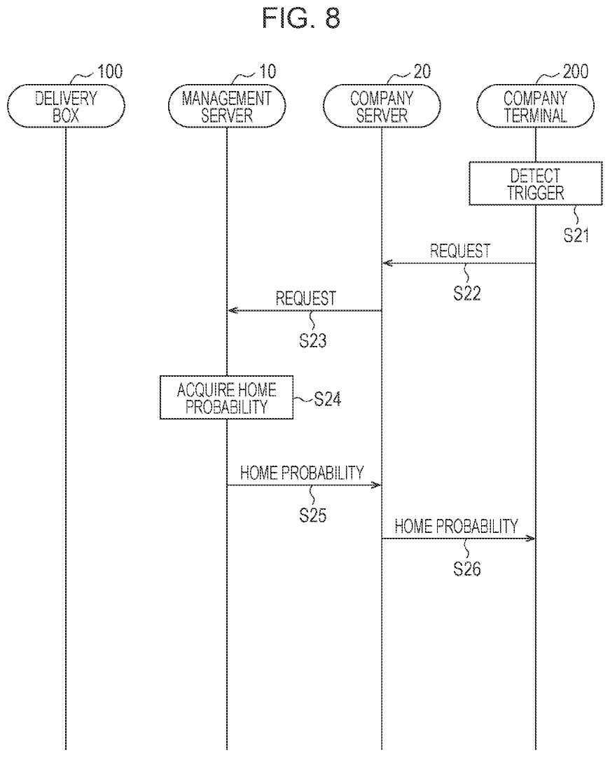

FIG. 8 is a diagram illustrating an example of an operation that the management server 10 returns the home probability of a specific recipient in response to a request from a delivery company in the system 1. FIG. 8, as well as FIG. 6, shows the sequence of operations of elements included in the system 1 sequentially from above in time sequence. As shown in FIG. 8, the elements included in the system 1 may include the delivery box 100, the management server 10, the company server 20, and the company terminal 200.

The time when the operation shown in FIG. 8 starts may be a scene where a staff member or the like of a delivery company intends to acquire the home probability of a specific recipient. At this time, the staff member or the like of the delivery company may input information for identifying the specific recipient to the company terminal 200 to make a request for the home probability of the recipient. Here, information for identifying the recipient may be, for example, input from the reading unit 208 or operating unit 210 of the company terminal 200. The company terminal 200 may issue a request when information for identifying the recipient is input as a trigger.

When the operation shown in FIG. 8 starts, the company terminal 200 detects input of information for identifying a recipient as a trigger (step S21). When the trigger is detected in step S21, the company terminal 200 sends a request for the home probability of the recipient of a package to the company server 20 (step S22).

When the request is received in step S22, the company server 20 sends a request for the home probability of the recipient of the package to the management server 10 (step S23).

When the request is received in step S23, the management server 10 acquires the home probability of the recipient from the storage unit 14 (step S24) and sends the home probability to the company server 20 (step S25).

When the home probability is received in step S25, the company server 20 sends the home probability to the company terminal 200 (step S26). After step S26, the company terminal 200 may display the home probability (first information) received from the company server 20 on the display unit 212.

As described above, the company terminal 200 is able to acquire the home probability of a specific recipient. When the company terminal 200 acquires the home probability of a recipient, a staff member of a delivery company is able to determine whether the recipient is home at time when a package is delivered. The staff member of the delivery company is able to deliver the package to the home or the like of the recipient by finding a right moment at which the home probability of the recipient is high in accordance with the home probability of the recipient. In addition, the staff member of the delivery company is able to, when the home probability of the recipient is low in accordance with the home probability of the recipient, not deliver the package to the home or the like of the recipient or assume to leave the package in the delivery box 100 in advance.

(Information Indicating Availability of Storage Apparatus (Second Information))

Next, an operation that the management server 10 returns the availability of a storage apparatus, such as the delivery box 100, in response to a request from the company terminal 200 or the company server 20 will be described as an operation in the system 1. Here, the availability of a storage apparatus may be information indicating whether there is any available storage portion 120 of the delivery box 100 installed in the home of a recipient of a package to be delivered and, when there is an available storage portion, the number of the available storage portions. Hereinafter, information indicating the availability of a storage apparatus, such as the delivery box 100, is also referred to as “second information”.

In one embodiment, the management server 10 controls and/or manages at least one delivery box 100 as described above. Therefore, the management server 10 is able to grasp in real time availability including the number of available storage portions 120 of a specific delivery box 100 under control. For this reason, the management server 10 is able to return the availability of the storage portion 120 of a specific delivery box 100 under control in response to a request from the company terminal 200 or the company server 20.

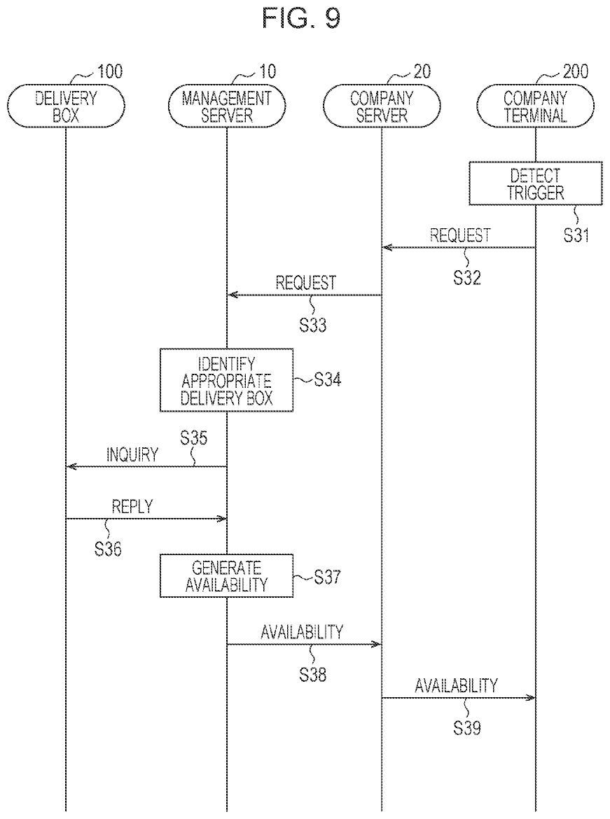

FIG. 9 is a diagram Illustrating an example of an operation that the management server 10 returns the availability of a specific delivery box 100 in response to a request from a delivery company in the system 1. FIG. 9, as well as FIG. 6, shows the sequence of operations of elements included in the system 1 sequentially from above in time sequence. As shown in FIG. 9, the elements included in the system 1 may include the delivery box 100, the management server 10, the company server 20, and the company terminal 200.

The time when the operation shown in FIG. 9 starts may be a scene where a staff member or the like of a delivery company intends to acquire the availability of the delivery box 100 of a specific recipient. At this time, the staff member or the like of the delivery company may input information for identifying the specific recipient to the company terminal 200 to make a request for the availability of the delivery box 100 of the recipient. Here, information for identifying the recipient may be, for example, input from the reading unit 208 or operating unit 210 of the company terminal 200. The company terminal 200 may issue a request when information for identifying the recipient is input as a trigger.

When the operation shown in FIG. 9 starts, the company terminal 200 detects input of information for identifying a recipient as a trigger (step S31). When the trigger is detected in step S31, the company terminal 200 sends a request for the home probability of the recipient of a package to the company server 20 (step S32).

When the request is received in step S32, the company server 20 sends a request for the availability of the delivery box 100 of the recipient to the management server 10 (step S33).

When the request is received in step S33, the management server 10 identifies the delivery box 100 of the recipient (step S34) and sends an inquiry about the availability of the identified delivery box 100 (step S35).

When the inquiry about the availability is received in step S35, the delivery box 100 acquires the availability of the storage portion 120 and answers the inquiry from the management server 10 (step S36).

When the answer is received in step S36, the management server 10 generates information on the availability of the delivery box 100 (step S37) and sends the availability to the company server 20 (step S38).

When the availability is received in step S38, the company server 20 sends the availability to the company terminal 200 (step S39). After step S39, the company terminal 200 may display the availability (second information) received from the company server 20 on the display unit 212.

As described above, the company terminal 200 is able to acquire the availability of the delivery box 100 of a specific recipient. When the company terminal 200 acquires the availability of the delivery box 100 of a recipient, a staff member of a delivery company, is able to determine whether a package can be left in the delivery box 100 if the recipient is absent. A staff member of a delivery company is able to, when there is an available space the delivery box 100 of a recipient, avoid a burdensome situation that the staff member brings back a package and accepts a redelivery, even when the recipient is absent. In addition, a staff member of a delivery company is able to, when there is no available space in the delivery box 100 of a recipient, grasp in advance the possibility of a burdensome situation that the staff member brings back a package and accepts a redelivery if the recipient is absent.

Any one set or both sets of a request and return of first information shown in FIG. 8 and a request and return of second information shown in FIG. 9 may be performed. In other words, the company terminal 200 may display first information indicating the home probability of a recipient of a package and second information indicating the availability of a storage apparatus on the display unit 212. When both the operation shown in FIG. 8 and the operation shown FIG. 9 are performed, either one may be performed first or both may be performed at the same time or substantially at the same time.

In this way, the controller 12 according to one embodiment executes control such that, in response to, for example, a request received by the communication unit 16 from another electronic device, such as the company server 20 and the company terminal 200, at least one of first information and second information is sent from the communication unit 16 to the other electronic device. As described above, first information may be information indicating the home probability of a recipient of a package to be delivered. First information may be information stored in the storage unit 14. Second information may be information indicating the availability of a storage apparatus, such as the delivery box 100, acquired from the storage apparatus.

With the system 1 including the management server 10 according to one embodiment, a staff member of a delivery company is able to easily acquire first information and/or second information of a specific recipient by using the company terminal 200 before delivery of a package, during delivery, or the like. Therefore, with the system 1 including the management server 10 according to one embodiment, a staff member of a delivery company is able to be informed in advance (that is, before delivery) that it is highly likely that a package can be directly handed to a recipient of which the home probability is relatively high. In addition, a staff member of a delivery company is able to be informed in advance that it is highly likely that a package cannot be directly handed to a recipient of which the home probability is relatively low. In this case, a staff member of a delivery company is able to be informed in advance (that is, before delivery) of the availability of the delivery box 100 installed in the home of a recipient by using the company terminal 200. Therefore, when a recipient is estimated to be absent (for example, the home probability of a recipient is relatively low) at the time when a staff member of a delivery company delivers a package to the recipient, a situation in which the staff member of the delivery company is forced to redeliver because of no available space in the delivery box 100 can be prevented.

Therefore, with the system 1 including the management server 10 according to one embodiment, a delivery company is able to grasp the likelihood of the presence of a recipient of a package and/or whether there is an available space in the delivery box 100, so the delivery company is able to efficiently deliver a package. In other words, with the system 1 including the management server 10 according to one embodiment, the delivery company is able to reduce effort to redeliver packages. With the system 1 including the management server 10 according to one embodiment, a recipient of a package is able to reduce time and effort to set a redelivery date and time by arranging for redelivery or to stay home at a redelivery date and time.

As described above, with the system 1 including the management server 10 according to one embodiment, the efficiency of delivery of a package can be promoted in a service to deliver a package to a recipient. With the system 1 including the management server 10 according to one embodiment, it can be useful for both a delivery company and a recipient of a package.

FIG. 9 illustrates an example in which the company terminal 200 acquires information on the availability of the delivery box 100 (second information) (step S39) in accordance with detection of a trigger (step S31). However, a mode in which the company terminal 200 acquires second information is not limited to the example shown in FIG. 9 and may be another mode. For example, in one embodiment, the company terminal 200 may acquire in real time information on the availability of the delivery box 100 for a specific recipient. For example, it is assumed that the management server 10 receives a request for information on the availability of the delivery box 100 for a specific recipient from the company terminal 200. In this case, the management server 10 may send information on the availability of the delivery box 100 at a current point in time to the company terminal 200 in accordance with the operation of FIG. 9. Then, the management server 10 may continue to make an inquiry about information on the availability of the delivery box 100 for a specific recipient at predetermined intervals and send the result to the company terminal 200. Only when there is a change in information on the availability of the delivery box 100 for a specific recipient, the management server 10 may send the result to the company terminal 200. With this configuration, a staff member of a delivery company is able to recognize in substantially real time the fact that there is a change in the availability of the delivery box 100 for a specific recipient by using the company terminal 200. As described above, information on the availability of the delivery box 100 (second information) can be changed in accordance with the fact that a package stored in the delivery box 100 is taken out by a recipient or the like.

FIG. 8 illustrates an example in which the company terminal 200 acquires information on the home probability of a recipient of a package (first information) (step S26) in accordance with detection of a trigger (step S21). However, a mode in which the company terminal 200 acquires first information is not limited to the example shown in FIG. 8 and may be another mode. For example, in one embodiment, when there is a change in information on the home probability of a specific recipient, the company terminal 200 may acquire the changed information. For example, it is assumed that the management server 10 receives a request for information on the home probability of a specific recipient from the company terminal 200. In this case, the management server 10 may send information on the home probability of the recipient at a current point in time to the company terminal 200 in accordance with the operation of FIG. 8. Then, the management server 10 may continue to make an inquiry about information on the home probability of the recipient at predetermined intervals and send the result to the company terminal 200. Only when there is a change in information on the home probability of the recipient, the management server 10 may send the result to the company terminal 200. With this configuration, when there is a change in the home probability of a specific recipient, a staff member of a delivery company is able to acquire the latest home probability by using the company terminal 200. As described above, information on the home probability of a recipient of a package (first information) can be changed in accordance with the fact that a package stored in the delivery box 100 is taken out by a recipient or the like.

In this way, in one embodiment, the controller 202 of the company terminal 200 may display, on the display unit 212, at least one of first information and second information changed in accordance with the fact that a package stored in a storage apparatus, such as the delivery box 100, is taken out.

(Generation of Delivery Plan by Company Server)

Next, an operation that the company server 20 generates a delivery plan of packages in response to delivery request information sent from the company terminal 200 will be described as an operation in the system 1. Here, delivery request information may include, for example, information on a sender (the name, address, and the like or a sender), information on a recipient (the name, address (destination), and the like of a recipient), information on a package (content, whether it is fragile, or the like), a delivery date and time (when specified), company ID, and the like. A package delivery plan may be information setting a delivery sequence, delivery route, and the like at the time when a staff member of a delivery company delivers packages. In other words, a package delivery plan may be information in which destinations to which a staff member of a delivery company delivers packages, an order in which packages are delivered to the places, a route at the time of delivering the packages, and the like are defined. For example, when there are a plurality of packages to be delivered by a staff member of a delivery company, a package delivery plan can be particularly important to efficiently perform the delivery.

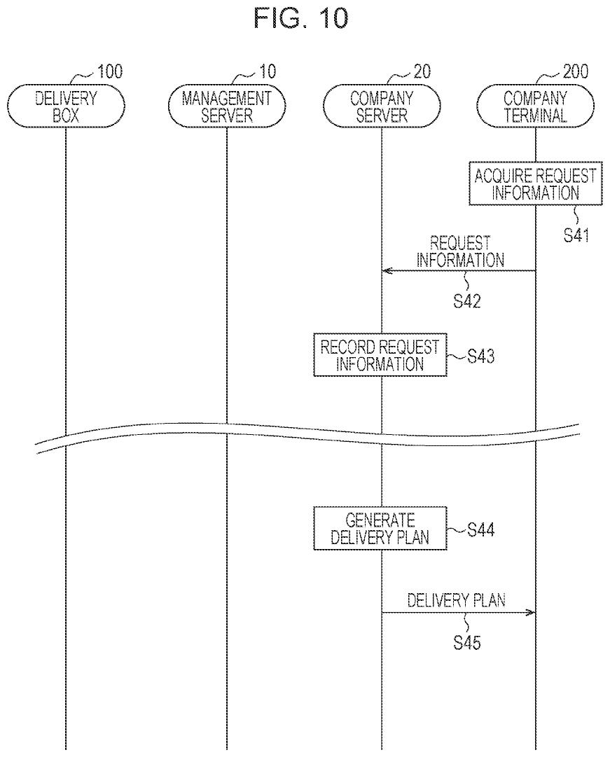

FIG. 10 is a diagram illustrating an example of an operation that the company server 20 receives delivery request information from the company terminal 200 and generates a delivery plan in the system 1. FIG. 10, as well as FIG. 6, shows the sequence of operations of elements included in the system 1 sequentially from above in time sequence. As shown in FIG. 10, the elements included in the system 1 may include the delivery box 100, the management server 10, the company server 20, and the company terminal 200.

The time when the operation shown in FIG. 10 starts may be a scene where a staff member or the like of a delivery company is requested to deliver a package from a customer and intends to input information on the package to the company terminal 200. Such a scene may be, for example, a scene where a staff member or the like of a delivery company visits a customer to pick up a package, or another scene.

When the operation shown in FIG. 10 starts, the company terminal 200 acquires request information for delivery of a package (step S41). In step S41, the company terminal 200 may acquire request information read by the reading unit 208 or request information input from the operating unit 210. Here, request information may, as described above, include, for example, information on a sender (the name, address, and the like of a sender), information on a recipient (the name, address (destination), and the like of a recipient), information on a package (content, whether it is fragile, or the like), a delivery date and time (when specified), company ID, and the like. When the request information is acquired in step S41, the company terminal 200 sends the acquired request information to the company server 20 (step S42).

When the request information is received in step S42, the company server 20 records the request information (step S43).

In one embodiment, the company terminal 200 and the company server 20 may repeat the operation from step S41 to step S43 in FIG. 10 each time a request to deliver a package is received. In one embodiment, the operation from step S41 to step S43 in FIG. 10 may be performed on one company server 20 from one company terminal 200. In one embodiment, the operation from step S41 to step S43 in FIG. 10 may be performed on the company server 20 from the company terminals 200 each used by a plurality of staff members of a delivery company. In other words, the company server 20 may receive all the pieces of request information on requests each received from a plurality of staff members of a delivery company. In this case, the company server 20 may be one, or respective pieces of request information may be shared between the plurality of company servers 20.

After the operation from step S41 to step S43 in FIG. 10, the company server 20 may make at least one of a request for first information shown in FIG. 8 (step S23) and a request for second information shown in FIG. 9 (step S33) as needed.

Subsequently to step S43 (and the operations of FIG. 8 and/or FIG. 9), the company server 20 generates a package delivery plan in accordance with at least any one of the first information, the second information, and the request information (step S44). When the package delivery plan is generated in step S44, the company server 20 sends the delivery plan to the company terminal 200 (step S45).

When the delivery plan is received in step S45, the company terminal 200 may display information based on the delivery plan on, for example, the display unit 212. With this configuration, a staff member of a delivery company is able to perform delivery work (for example, driving a delivery vehicle and delivering a package) while referencing information based on the delivery plan displayed on the display unit 212 of the company terminal 200.

In this way, the controller 12 of the management server 10 may send at least one of first information and second information from the communication unit 16 to, for example, another electronic device, such as the company server 20. Here, another electronic device, such as the company server 20, may have the function of creating a plan to deliver a package to at least one destination.

With the company server 20 according to one embodiment, when generating a package delivery plan, it is possible to consider the home probability of a recipient of a package and/or the availability of the delivery box 100 installed in the home of the recipient. Therefore, with a delivery plan to be generated by the company server 20 according to one embodiment, extremely efficient delivery can be achieved.

(Generation of Delivery Plan by Management Server)

In the embodiment shown in FIG. 10, the company server 20 generates a delivery plan. In the system 1 according to one embodiment, a delivery plan may be generated not by the company server 20 but by the management server 10. In this way, in one embodiment, the controller 12 may generate a plan to deliver a package to at least one destination in accordance with at least one of first information and second information.

(Cooperation with Recipient Terminal)

Next, a mode in which the above-described system cooperates with a terminal used by a recipient of a package will be described.

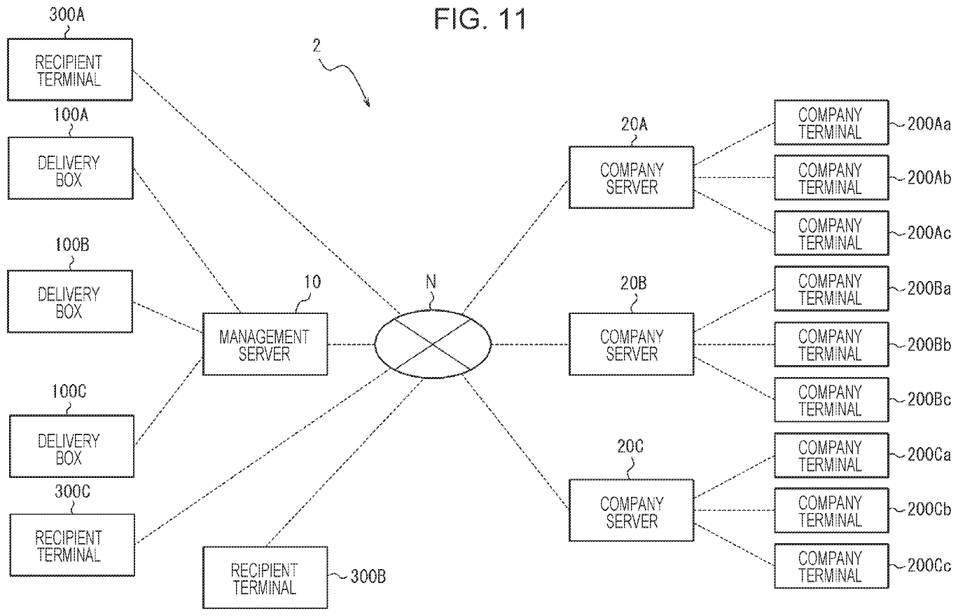

FIG. 11 is a diagram showing the configuration of a system according to one embodiment. The system 2 according to one embodiment shown in FIG. 11 further includes recipient terminals 300 in the system 1 shown in FIG. 1. FIG. 11 shows an example in which the system 2 includes a recipient terminal 300A, a recipient terminal 300B, and a recipient terminal 300C. In the present disclosure, when a plurality of recipient terminals such as the recipient terminal 300A and the recipient terminal 300B are not distinguished from each other, the plurality of recipient terminals may be simply referred to as “recipient terminals 300”.

As shown in FIG. 11, it is assumed that the recipient terminal 300A is used by a recipient who lives in a home in which the delivery box 100A is installed. As shown in FIG. 11, it is assumed that the recipient terminal 300C is used by a recipient who lives in a home in which the delivery box 100C is installed. In contrast, as shown in FIG. 11, it is assumed that the recipient terminal 300B is used by a recipient who lives in a home in which no delivery box is installed.

In FIG. 11, the recipient terminals 300 are connected to the management server 10 via the network N. However, the recipient terminals 300 may be connected to the management server 10 without intervening the network N. The recipient terminals 300 may be, for example, connected in a wired or wireless manner to at least any one of the delivery box 100, the company server 20, and the company terminal 200.

The recipient terminal 300 according to one embodiment may be a dedicated terminal adapted to the system 2 or may be, for example, an existing smartphone, cellular phone, tablet terminal, or the like. When, for example, an existing smartphone, cellular phone, tablet terminal, or the like is used as the recipient terminal 300, for example, an application to be used in the system 2 may be installed in the recipient terminal 300. The recipient terminal 300 may be implemented on an internet browser. In this case, the recipient terminal 300 is not limited to a smartphone, a cellular phone, a tablet terminal, or the like and may be a notebook PC, a desktop PC, or the like.

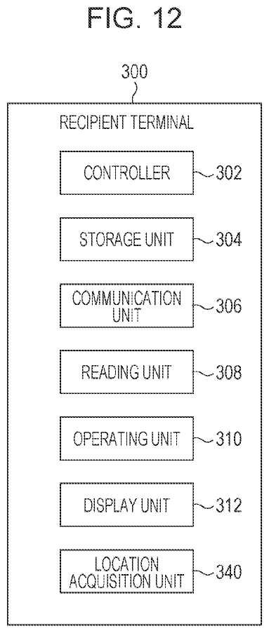

FIG. 12 is a functional block diagram schematically showing the configuration of the recipient terminal 300 according to one embodiment. In FIG. 12, the recipient terminal 300 is, for example, configured such that, for example, an application to be used in the system 2 is installed in an existing smartphone.

As in the case of the example shown in FIG. 12, the recipient terminal 300 may have a configuration similar to that of the company terminal 200 shown in FIG. 5. The recipient terminal 300 shown in FIG. 12 may include a controller 302, a storage unit 304, a communication unit 306, a reading unit 308, an operating unit 310, a display unit 312, and a location acquisition unit 340. These functional units may correspond to the functional units shown in FIG. 5, that is, the controller 202, the storage unit 204, the communication unit 206, the reading unit 208, the operating unit 210, the display unit 212, and the location acquisition unit 240.

Next, the operation of the system 2 including the management server 10 according to one embodiment will be further described. The system 2 including the management server 10 according to one embodiment, as well as the above-described system 1, can be used in various scenes where a delivery company or the like provides a service on delivery.

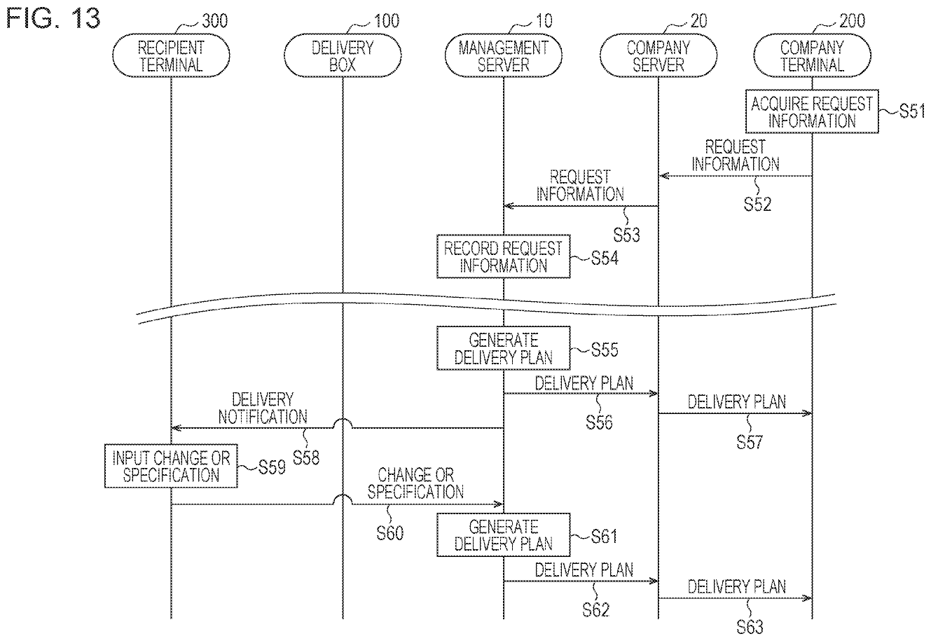

FIG. 13 is a diagram illustrating the operation of the system 2 including the management server 10 according to one embodiment. FIG. 13 is a diagram showing a mode in which the operation of the system 1 shown in FIG. 10 is applied to the system 2 including the recipient terminal 300. FIG. 13, as well as FIG. 6, shows the sequence of operations of elements included in the system 2 sequentially from above in time sequence. As shown in FIG. 13, the elements included in the system 2 may include the delivery box 100, the management server 10, the company server 20, the company terminal 200, and the recipient terminal 300.

In the operation of the system 1 described in FIG. 10, the company server 20 generates a delivery plan (step S44). In contrast, in the operation of the system 2 described in FIG. 13, the management server 10 generates a delivery plan (step S55). In the system 2, the management server 10 generates a delivery plan, so, for example, pieces of request information of different companies each acquired by the plurality of company servers 20 used by different companies can be collected in the management server 10. Therefore, the management server 10 is able to generate and send a delivery plan to each of the companies in accordance with request information from an associated one of the plurality of company servers 20 used by different companies. In this case, the management server 10 may take security measures such that information of a company is not sent to another company.

The time when the operation shown in FIG. 13 starts, as well as the scene of FIG. 10, may be a scene where a staff member or the like of a delivery company is requested to deliver a package from a customer and intends to input information on the package to the company terminal 200. Such a scene may be, for example, a scene where a staff member or the like of a delivery company visits a customer to pick up a package, or another scene.

When the operation shown in FIG. 13 starts, the company terminal 200 acquires request information for delivery of a package (step S51). In step S51, the company terminal 200 may acquire request information read by the reading unit 208 or request information input from the operating unit 210. Here, request information may, as described above, include, for example, information on a sender (the name, address, and the like of a sender), information on a recipient (the name, address (destination), and the like of a recipient), information on a package (content, whether it is fragile, or the like), a delivery date and time (when specified), company ID, and the like. When the request information is acquired in step S51, the company terminal 200 sends the acquired request information to the company server 20 (step S52).

When the request information is received in step S52, the company server 20 sends the request information to the management server 10 (step S53).

When the request information is received in step S53, the management server 10 records the request information (step S54).

In one embodiment, the company terminal 200, the company server 20, and the management server 10 may repeat the operation from step S51 to step S54 in FIG. 13 each time a request to deliver a package is received. In one embodiment, the operation from step S51 to step S54 in FIG. 13 may be performed on one company server 20 from one company terminal 200. In one embodiment, the operation from step S51 to step S54 in FIG. 13 may be performed on the company server 20 from the company terminals 200 each used by a plurality of staff members of a delivery company. In other words, the company server 20 may receive all the pieces of request information on requests each received from a plurality of staff members of a delivery company. In this case, the company server 20 may be one, or respective pieces of request information may be shared between the plurality of company servers 20.

After the operation from step S51 to step S54 in FIG. 13, the management server 10 may make at least one of acquisition of first information shown in FIG. 8 (step S24) and an inquiry about second information shown in FIG. 9 (step S35) as needed.

Subsequently to step S54 (and the operations of FIG. 8 and/or FIG. 9), the management server 10 generates a package delivery plan in accordance with at least any one of the first information, the second information, and the request information (step S55). When the package delivery plan is generated in step S55, the management server 10 sends the delivery plan to the company server 20 (step S56).

When the delivery plan is received in step S56, the company server 20 sends the delivery plan to the company terminal 200 (step S57).

When the delivery plan is received in step S57, the company terminal 200 may display information based on the delivery plan on, for example, the display unit 212. With this configuration, a staff member of a delivery company is able to perform delivery work (for example, driving a delivery vehicle and delivering a package) while referencing information based on the delivery plan displayed on the display unit 212 of the company terminal 200.

After step S55, the management server 10 sends delivery notification based on the delivery plan to the recipient terminal 300 of a recipient to which a delivery is scheduled (step S58). In step S58, a recipient may be identified from information on the recipient (the name, address (destination), and the like of the recipient) included in the request information on a package requested for delivery, and delivery notification may be sent to the recipient terminal 300 used by the identified recipient. Here, delivery notification may be, for example, notification of information on a sender the name, address, and the like of a sender), information on a package (content, whether it is fragile, or the like), a delivery date and time (when specified), a company name based on company ID, and the like. These pieces of information may be based on information included in the request information on a package requested for delivery.

When the delivery notification is received in step S58, the recipient terminal 300 may display the received delivery notification on, for example, the display unit 312 or the like. Here, the recipient terminal 300 may display the delivery notification on the display unit 312 as, for example, at least any one of message, e-mail, notification, and the like.

When the delivery notification is displayed in this way, the recipient who uses the recipient terminal 300 is able to be informed of the fact that a package is scheduled to be delivered to the recipient together with a scheduled delivery date and time. In addition, a recipient who uses the recipient terminal 300 may be able to be informed of at least any one of information on a sender of a package scheduled to be delivered, the content of a package, the name of a delivery company, and the like.

After the delivery notification is received in step S58, the recipient who uses the recipient terminal 300 is able to make a request to change a delivery date and time or specify a yet-to-be set delivery date and time. The recipient terminal 300 may detect input of a change or specification of a delivery date and time by the recipient with the operating unit 310 (step S59). When a change or specification of a delivery date and time is input in step S59, the recipient terminal 300 sends the change or specification to the management server 10 (step S60).

When the change or specification of a delivery date and time is received in step S60, the management server 10 generates a delivery plan for a package in accordance with at least any one of the first information, the second information, the request information, and the change or specification of a delivery date and time (step S61). When the package delivery plan is generated in step S61, the management server 10 sends the delivery plan to the company server 20 (step S62).

When the delivery plan is received in step S62, the company server 20 sends the delivery plan to the company terminal 200 (step S63).

In step S61, the management server 10 may send a changed delivery plan to the company server 20 (step S62) only when the generated delivery plan is changed from the previously generated delivery plan.

When the delivery plan is received in step S63, the company terminal 200 may display information based on the delivery plan on, for example, the display unit 212. With this configuration, a staff member of a delivery company is able to perform delivery work (for example, driving a delivery vehicle and delivering a package) while referencing information based on the delivery plan displayed on the display unit 212 of the company terminal 200.

In this way, in one embodiment, the controller 12 of the management server 10 may generate a plan to deliver a package to at least one destination in accordance with at least one of first information and second information.

In one embodiment, the communication unit 16 may receive third information from another electronic device, such as the company server 20 and the company terminal 200. Here, third information may be information including a request to deliver a package. When the communication unit 16 receives the third information, the controller 12 may generate a plan to deliver a package to at least one destination in accordance with at least one of the first information and the second information, and the third information.

In one embodiment, when a plan to deliver a package to at least one destination (delivery plan) is created by the controller 12, the controller 12 may send the plan from the communication unit 16 to another electronic device, such as the company server 20 and the company terminal 200. In one embodiment, the controller 12 may send information on a delivery schedule of a package, included in the plan, from the communication unit 16 to a terminal of a recipient of the package (recipient terminal 300). In one embodiment, the communication unit 16 may receive information indicating a change of a delivery schedule from a terminal of a recipient of a package. In this case, when the communication unit 16 receives information indicating a request to change a delivery schedule, the controller 12 may recreate the plan (delivery plan).

With the system 2 according to one embodiment, when generating a package delivery plan, the management server 10 is able to consider the home probability of a recipient of a package and/or the availability of the delivery box 100 installed in the home of the recipient. Therefore, with a delivery plan to be generated by the management server 10 according to one embodiment, an extremely efficient delivery can be achieved.

With the system 2 according to one embodiment, when a plan to deliver a package to a recipient is generated, notification is sent to the recipient. Therefore, the recipient is able to be informed of the fact that a package is scheduled to be delivered to the recipient together with a scheduled delivery date and time. The recipient who receives the notification is able to make a request to change a delivery schedule or specify a scheduled delivery date and time when, for example, a scheduled delivery date and time is inconvenient.

When no delivery box is installed in a home as in the case of a recipient who uses the recipient terminal 300B described in FIG. 11, the management server 10 is not able to acquire first information or second information on the recipient. In other words, a recipient who uses the recipient terminal 300B does not use a delivery box, so the home probability based on the history of use of a delivery box cannot be determined, and the availability of a delivery box also cannot be acquired.

However, with the system 2 according to one embodiment, regardless of whether a recipient uses a delivery box, the fact that a package is scheduled to be delivered to the recipient and a date and time are able to be informed by the recipient terminal 300. Furthermore, with the system 2, it is possible to make a request to change a delivery schedule or specify a scheduled delivery date and time through the recipient terminal 300. Therefore, with the system 2 according to one embodiment, it can also be useful for a recipient who does not use a delivery box.

As described above, with the system 2 including the management server 10 according to one embodiment, the efficiency of delivery of a package can be promoted in a service to deliver a package to a recipient. With the system 2 including the management server 10 according to one embodiment, it can be useful for both a delivery company and a recipient of a package.

The present disclosure has been described in accordance with the drawings and the embodiments, and it should be noted that a person skilled in the art is able to easily make various modifications or corrections in accordance with the present disclosure. Therefore, it is rioted that these modifications or corrections are included in the scope of the present disclosure. For example, functions and the like included in the functional units may be rearranged without any logical contradiction. The plurality of functional units and the like may be combined as one or may be divided. Each of the embodiments according to the above-described present disclosure is not limited to be faithfully implemented in accordance with the described embodiments and can be implemented by combining features or partially omitting as needed.

In the above-described embodiments, the home probability of a recipient of a package is determined in accordance with time at which the package stored in the delivery box 100 is taken out by the recipient. The delivery box 100 is not limited to only the use to store a package when a recipient is absent, but the delivery box 100 may be used to store a package until a staff member of a delivery company visits to pick up the package when making a request to deliver a package. Therefore, in one embodiment, the home probability of a recipient of a package may be determined in accordance with time at which a package is stored in the delivery box 100 at the time when the recipient makes a request to deliver the package.

In this case, until a point in time at which a recipient stores a package in the delivery box 100, the home probability of the recipient may be determined to be relatively high. From a point in time at which a recipient stores a package in the delivery box 100, the home probability of the recipient may be determined to be relatively low. The home probability of a recipient may be gradually increased until a point in time at which a recipient stores a package in the delivery box 100, and the home probability of the recipient is at the peak at the point in time at which the recipient stores the package in the delivery box 100. During a predetermined period of time until a point in time at which a recipient stores a package in the delivery box 100, the home probability of the recipient may be determined to be higher than or equal to a predetermined probability.

A location where the delivery box 100 according to one embodiment is installed is not limited to, for example, the entrance or the like of a collective housing, such as a condominium. For example, the delivery box 100 according to one embodiment may be installed in a public space, such as a train station, or a shop, such as a convenience store.

### REFERENCE SIGNS LIST

1, 2 delivery management system

10 management server

12 controller

14 storage unit

16 communication unit

20 company server

22 controller

24 storage unit

26 communication unit

100 delivery box

102 controller

104 storage unit

106 communication unit

108 reading unit

110 operating unit

112 display unit

120 storage portion

122 door

124 electronic lock

130 open-close detecting unit

132 weight detecting unit

200 company terminal

202 controller

300 recipient terminal

204, 304 storage unit

206, 306 communication unit

208, 308 reading unit

210, 310 operating unit

212, 312 display unit

240, 340 location acquisition unit

1. A server capable of connecting in a wired or wireless manner to a storage apparatus that stores a package delivered to a recipient, and an other electronic device, the server comprising:
a communication unit that communicates with the storage apparatus and the other electronic device;
a storage unit that stores first information indicating a home probability of the recipient of the package; and
a controller that controls the communication unit such that the first information stored in the storage unit and second information that is acquired from the storage apparatus and that indicates an availability of the storage apparatus are sent to the other electronic device in response to a request from the other electronic device, received by the communication unit.

2. The server according to claim 1, wherein
the communication unit receives, from the storage apparatus, information indicating time at which a package stored in the storage apparatus is taken out by a recipient of the package, and
the controller determines a home probability of the recipient in accordance with the time.

3. The server according to claim 2, wherein the controller determines the home probability of the recipient such that the home probability of the recipient is higher than or equal to a predetermined probability during a predetermined period of time from time at which a package stored in the storage apparatus is taken out by the recipient of the package.

4. The server according to claim 2, wherein the controller determines the home probability of the recipient such that the home probability of the recipient is at a peak at time at which a package stored in the storage apparatus is taken out by the recipient and, after the time, the home probability of the recipient gradually decreases.

5. The server according to claim 2, wherein the controller determines the home probability of the recipient such that the home probability of the recipient is lower than or equal to a predetermined home probability for a period of time from time at which a package stored in the storage apparatus s been stored in the storage apparatus to time at which the package is taken out by the recipient.

6. The server according to claim 1, wherein
the communication unit receives, from the other electronic device, information indicating time at which the package is received by the recipient, and
the controller determines the home probability of the recipient in accordance with the time.

7. The server according to claim 1, wherein
the communication unit receives, from the other electronic device, information indicating time specified by the recipient, and
the controller determines the home probability of the recipient in accordance with the time.

8. The server according to claim 1, wherein the controller determines the home probability of the recipient in a predetermined time frame in accordance with the first information stored in the storage unit.

9. The server according to claim 1, wherein the controller causes the communication unit to send the first information and the second information to the other electronic device that generates a plan for delivering a package to at least one destination.

10. The server according to claim 1, wherein the controller generates a plan for delivering a package to at least one destination in accordance with the first information and the second information.

11. The server according to claim 10, wherein, when the controller receives third information including a request for delivery from the other electronic device through the communication unit, the controller generates a plan for delivering a package to at least one destination in accordance with the first information and the second information, and the third information.

12. The server according to claim 10, wherein, when the controller generates a plan for delivering a package to at least one destination, the controller causes the communication unit to send the plan to the other electronic device.

13. The server according to claim 12, wherein the controller causes the communication unit to send information about a delivery schedule of a package, included in the plan, to a terminal of a recipient of the package.

14. The server according to claim 13, wherein, when the controller receives information indicating a request to change a delivery schedule from the terminal of the recipient of the package through the communication unit, the controller generates the plan again.

15. A cloud server according to claim 1.

16. A non-transitory computer-readable recording medium storing computer program instructions, which when executed by a computer, capable of connecting in a wired or wireless manner to a storage apparatus that stores a package delivered to a recipient, and an other electronic device, cause the computer to:
communicate, by a communication unit, with the storage apparatus and the other electronic device;
store, by a storage unit, first information indicating a home probability of the recipient of the package; and
control, by a controller, the communication unit such that the first information stored in the storage unit and second information that is acquired from the storage apparatus and that indicates an availability of the storage apparatus are sent to the other electronic device in response to a request from the other electronic device, received by the communication unit.

17. An electronic device comprising:
a communication unit that directly or indirectly communicates with a storage apparatus that stores a package;
a display unit that displays first information indicating a home probability of a recipient of the package and second information indicating an availability of the storage apparatus; and
a controller that displays on the display unit at least one of the first information and the second information, changed in accordance with a fact that the package stored in the storage apparatus is taken out.
